(19) United States
(12) Patent Application Publication
(10) Pub. No.: US 2026/0233419 A1
(43) Pub. Date: Aug. 13, 2026

(54) Method for Producing a Support Structure

(71) Applicant: Bayerische Motoren Werke Aktiengesellschaft, Muenchen (DE)

(72) Inventors: Markus HUBER, Woerth (DE); Peter KOSTORZ, Pfaffenhofen a. d. Ilm (DE); Robert KREUZPOINTNER, Buchbach (DE)

(21) Appl. No.: 19/470,862

(22) PCT Filed: Jun. 21, 2024
(86) PCT No.: PCT/EP2024/067393

§ 371 Date: Sep. 30, 2025

(30) Foreign Application Priority Data
Jul. 10, 2023 (DE) 10 2023 118 165.3

(51) Int. Cl. B25J 19/00; B25J 15/00; B33Y 80/00

(52) U.S. Cl. CPC B25J 19/007; B25J 15/00; B33Y 80/00

(57) ABSTRACT

A method for producing a support structure for a handling device for handling objects, in particular vehicle parts, said support structure being coupled or coupleable to a movement device, in particular a multi-axis robot, of the handling device and being designed to connect at least one end effector to the movement device, wherein the support structure is formed as a single part, in particular in an integral manner, on the basis of a three-dimensional model of the support structure.

### BACKGROUND AND SUMMARY

This disclosure relates to a method for producing a support structure for a handling device for handling objects, in particular vehicle parts, the support structure being couplable to or coupled to a motion device of the handling device, in particular a multi-axis robot, and being configured to connect at least one end effector to the motion device.

Handling devices that are configured to handle objects, for example vehicle parts, and have a motion device, for example a gantry or a multi-axis robot, which is connected to at least one end effector by a support structure, are known in principle from the prior art. By way of example, suction cups, grippers or similar components or assemblies can be used as end effectors, through which the handling device can interact with the objects. For example, handling devices can therefore move vehicle parts, for example underbodies, roofs, or hoods, between workstations, i.e. remove them from a first workstation and place them in a second workstation. The handling operations are in principle arbitrary in this case, wherein in addition to handling, the term “handling” can also encompass processing, so that corresponding end effectors that are configured to process parts of the objects can likewise be arranged on the support structure.

From the prior art, a standardized system for providing support structures of this kind is known as “Euro Gripper Tooling” or “EGT.” EGT components of this kind form a modular kit comprising multiple different predefined components, which are typically designed based on perforated octagonal profiles. In order to be able to handle different objects, for example different vehicle parts, using the handling device, a support structure is typically assembled from different individual parts of the kit. This makes assembly labor-intensive because the individual components have to be selected and assembled with one another. Moreover, there are disadvantages in terms of design freedom and total weight of the support structure, because only the components available in the kit can be used to approximate the desired or ideal geometry.

Due to a trend toward heavier and/or larger vehicles or vehicle parts, the overall weight of the handling device, in particular the weight of the objects to be handled and of the support structure, increases, so that the motion devices used may no longer be sufficient to handle the overall weight. This leads to a need either to reduce the travel speed of the motion device due to the increased inertia of the moving mass, or else more powerful motion devices, which are correspondingly more complex, more expensive, and more energy-intensive, have to be used.

With regard to the modular-kit components described above, it should also be noted that, due to their structure, in particular the perforated octagonal-profile structure, maintenance, and specifically cleaning, is laborious. For example, contaminants can accumulate in the perforated structure, so that use of the support structures known from the prior art is difficult in certain work areas, in particular in cleanroom environments and in dust-laden environments, because a structure of this kind can accumulate contamination and release it in an unpredictable manner, potentially contaminating sensitive work environments.

The disclosure is based on the object of specifying an improved method for producing a support structure.

As described, the disclosure relates to a method for producing a support structure for a handling device for handling objects, in particular vehicle parts, the support structure being couplable or coupled to a motion device of the handling device, particularly a multi-axis robot, and configured to connect at least one end effector to the motion device. As described, the present method is used to produce a support structure for a handling device, which handling device is configured for handling objects. The handling device has a motion device which may, for example, be implemented as a multi-axis robot, and be coupled to the support structure. For this purpose, the support structure may have at least one mounting plate or connection interface by which the support structure can be fastened to the motion device. For example, the support structure can be bolted to the motion device at its connection interface. The support structure thereby provides the connection between the motion device and at least one end effector. In particular, each end effector of the handling device can be connected to the motion device via the support structure. For connecting the at least one end effector, the support structure can provide at least one connection region.

The disclosure is based on the recognition that the support structure is produced in one piece, in particular as a monolithic part, based on a three-dimensional model of the support structure. Instead of constructing the support structure from individual components available in a standardized modular kit, it is proposed to generate or provide a three-dimensional model of the support structure and to produce the support structure in one piece on the basis of this three-dimensional model.

In this context, “in one piece” particularly defines that the support structure is not assembled from individual parts, but is produced as a single component in the manufacturing process. The term “in one piece” is therefore to be understood in particular as “monolithic,” so that the support structure is produced from a single piece, in particular without seams, separation lines, or joints, for example screw or welded joints or the like. As a result, assembly effort is reduced compared with the modular kit known from the prior art. In addition, design freedom is increased, since the three-dimensional model of the support structure can be generated to meet the requirements of the respective handling operation, for example tailored to the object to be handled rather than having to be approximated using standardized components.

The three-dimensional model in this case can be optimized with regard to the handling task, for example the object to be handled, so that the shaping of the support structure can be made more efficient. This makes it possible, in coordination with the object to be handled, to meet the boundary conditions underlying the handling task without unnecessarily increasing the weight of the support structure. In particular, a weight-optimized support structure can be provided in this way.

During the handling of vehicle parts as objects that are comparatively large and/or heavy, for example vehicle floor assemblies, doors, roofs, and the like, a support structure can be realized that is substantially lighter than would be achievable with standardized components from the modular kit described. Corresponding objects typically have a length of more than 1 m and/or a weight of more than 50 kg, wherein combinations thereof are possible. The support structure described can advantageously be realized both for comparatively light and large components, such as GRP roofs, and for smaller and heavier components, or for a combination of large and heavy components, for example vehicle floor assemblies.

Accordingly, in combination with the comparatively light support structure and the object to be handled, it is possible to handle comparatively heavier objects with one and the same robot, i.e. with the same motion device, because the comparatively higher weight of the object can be offset by the comparatively lighter support structure, so that the requirements placed on the motion device are not exceeded. Consequently, the use of heavy-duty robots as the motion device can be avoided, and instead lighter, less complex, and therefore more cost-effective motion devices can be used, in particular multi-axis robots.

In one embodiment of the method, the three-dimensional model of the support structure described above is generated, particularly in an automated manner, by way of a combination of at least two different optimizers. This offers the advantage that the benefits of different optimizers can be exploited in combination, wherein the drawbacks of the individual optimizers can be offset against one another or need not be accepted. In other words, the advantages of each optimizer can be utilized without implementing the disadvantages of the individual optimizers.

In particular, the three-dimensional model of the support structure can be generated automatically by using a combination of at least two optimizers. This makes it possible, compared with the use of a single optimizer, for example, to avoid a high degree of manual design effort. Instead, the support structure can be generated automatically between the connection interface to the motion device and the connection regions to the at least one end effector, for example. For this purpose, a first optimizer can be used initially, the intermediate result of which can be supplied to a second optimizer that can output the final model of the support structure. Use of the individual optimizers is described in detail below. In this case, the term “optimizer” refers in particular to a device or control device or a software module which, taking into account requirements or boundary conditions, can output a three-dimensional shape of the support structure.

According to a development of the method described, a basic form of the support structure that describes a spatial course of support elements is generated by way of a first optimizer. As described, the support structure can have at least one connection interface and at least one connection region, wherein the connection to the motion device takes place at the connection interface and the connection of the at least one end effector takes place at the connection region. By way of example, the end effector can be configured as a gripper with which the object for handling is fastened to the support structure, wherein the connection interface can be implemented as a mounting plate with which the support structure is connected to the motion device. The support elements of the support structure can be understood, for example, as struts which branch with one another where necessary and extend, at least in part, for example in a networked manner, from the connection interface to the connection region.

The geometry of the support elements, and in particular their spatial arrangement, defines the stiffness and the force and torque uptake of the support structure. The first optimizer described above may, for example, within the scope of a finite element method (FEM), output the basic form of the support structure taking into account the input boundary conditions, particularly the arrangement of the connection interface and of the at least one connection region, and specifying the acting forces or torques. The basic form of the support structure can at least describe the course of the support elements, i.e. specify how support elements must run in three dimensions, in order to be able to achieve a desired stiffness. In this case, the first optimizer can perform a topology optimization with respect to the number and course of the support elements of the support structure. The first optimizer takes into account the stiffness of the support structure or its three-dimensional model, in particular.

It can further be provided in the method that, by way of a second optimizer, particularly by iteratively refining volume elements of a build space, the three-dimensional model of the support structure is generated based on the basic form produced by way of the first optimizer. The “basic form” that is output by the first optimizer and supplied to the second optimizer can therefore be regarded as an intermediate step. In the first optimization step executed by the first optimizer, the build space may, for example, be meshed into defined volume elements of equal volume. Because this yields a comparatively coarse grid that typically requires extensive manual rework, the second optimizer is used to generate the three-dimensional model of the support structure based on the basic form produced. The second optimizer can, in particular, take account of stresses in the three-dimensional model of the support structure.

By combining at least the two optimizers, it is ensured that the required stiffness is achieved by the support structure generated and that stresses within the support structure are avoided or lie within permissible (specified) limits. The iterative refinement of the volume elements further ensures that the target surface meets the given requirements and, in particular, is generated as a “smooth” or “reconstructable” surface. In this context, the second optimizer can, in particular, adapt the cross sections of the support elements, the spatial course of which was prescribed by the first optimizer. In the basic form output by the first optimizer, the support elements, or the courses thereof, can be embodied as offsets or minimally thin members, i.e. with a minimum thickness, so that the second optimizer can generate the three-dimensional model of the support structure therefrom.

It can further be provided in the method that the basic form generated by the first optimizer defines at least one region that is unmodifiable for the second optimizer, in particular a skeleton of the support structure, wherein the second optimizer performs an adjustment of at least a cross section of an unmodifiable region. In the context of this embodiment, the term “unmodifiable region” is to be understood such that the course of the basic form, in particular the spatial course of a support element, cannot be changed by the second optimizer. The unmodifiable region of the basic form is therefore to be regarded by the second optimizer as a “non-design space” that cannot be altered. This means that the course of the support elements from the basic form is, in any event, also implemented in the model of the support structure.

However, the second optimizer can adapt the thickness or the size of the cross-section of unmodifiable regions of this kind or add material in the model of the support structure around the unmodifiable regions. Because the second optimizer takes account of stresses in particular, specifying the unmodifiable regions results in the three-dimensional model of the support structure generated by the second optimizer based on the basic form adopting in an unchanged fashion the spatial courses of the support elements that were incorporated by the first optimizer—specifically with regard to stiffness. The combination of the two optimizers therefore takes optimal account both of the stiffness of the support structure and the stresses thereof. In principle, any optimizers can be used as the first optimizer and the second optimizer. Advantageously, the first optimizer is an optimizer that performs topology optimization based on stiffness, and the second optimizer is an optimizer that takes into account stresses in the component or in the support structure. Purely by way of example, “OptiStruct” can be used as the first optimizer and “Emendate” as the second optimizer.

By way of example, in carrying out the method it can be provided that, for generating the three-dimensional model of the support structure, a build space and connection points of the support structure are specified and, particularly for the first optimizer, at least one boundary condition of the support structure is defined, in particular a force and/or a torque and/or an allowable deformation, wherein the three-dimensional model, in particular the basic form, is then generated based on the build space, the connection points, and the at least one boundary condition. As described above, the basic form can be regarded as an intermediate step or “intermediate model.” The connection points of the support structure can, in particular, be understood to be the connection interface described above and the connection regions, or the at least one connection region, for the at least one end effector. In other words, the build space that is fundamentally available for generating the three-dimensional model is specified. The build space can, for example, be defined in such a manner that the maximum dimensions of the support structure can be maintained. As boundary conditions, the loads that must be provided or borne by the support structure are specified. The first optimizer can then output the basic form in such a manner that, taking stiffness into account, the support structure has the corresponding support elements to satisfy the boundary conditions.

As described above, the basic form can be supplied to the second optimizer, in order to output the three-dimensional model of the support structure. The support structure can then be produced based on the three-dimensional model.

In a development of the method, it can be provided that the support structure is produced, based on the three-dimensional model, by way of an additive manufacturing process, in particular in layers, or that, based on the three-dimensional model, a casting mold is produced, in particular additively, and the support structure is cast. In principle, it is therefore possible to produce the support structure “forward,” in particular in layers by an additive manufacturing process, for example SLS or SLM. Alternatively, the support structure can also be produced “backward” based on the three-dimensional model by generating a negative of the three-dimensional model as a casting mold and then producing the support structure by casting, in particular aluminum die casting, in the mold. After demolding, the support structure is obtained.

By way of example, the casting mold can be produced as a casting core or as a core package comprising multiple casting cores. In this case, sand casting can be used in particular, i.e. the at least one casting core is produced from sand, for example by three-dimensional printing. The individual casting cores can, for example, be bonded together by way of core adhesive. The final casting mold can, where appropriate following the removal of unbonded build material, e.g. sand, be filled with the material from which the support structure is to be formed, for example by introducing molten aluminum, which can be demolded after curing or cooling.

By forming the support structure in one piece or as a monolithic part, further advantages can be achieved, particularly compared with support structures produced from individual modular components. For example, it can be provided that a surface of the support structure, in particular the entire surface of the support structure, is produced as a closed surface and/or that the support structure is produced free of cavities. For instance, by building up in layers or by casting, as described, the support structure can be produced, wherein the outer surface, in particular the entire outer surface, is closed, so that no openings result.

Alternatively or in addition, it can be provided that the support structure is produced to be free of cavities. In both variants, it can be ensured that contaminants cannot accumulate within the support structure and then, for example at random, be taken up into and released back into the work environment. In particular, no moisture and no further contaminants, such as weld spatter, dust, and the like, can accumulate within the support structure. This allows, in particular, the support structure to be used in cleanrooms too or, alternately, in contaminated environments and cleanrooms. Maintenance and, in particular, cleaning of the support structure are thereby significantly improved because the support structure does not have hard-to-access or inaccessible regions.

In addition to the method described, the disclosure relates to a support structure for a handling device for handling objects, in particular vehicle parts, the support structure being produced by way of a method as described above.

The disclosure further relates to a method for generating a three-dimensional model of a support structure for a handling device for handling objects, in particular vehicle parts, the support structure being couplable to or coupled to a motion device of the handling device, in particular a multi-axis robot, and configured to connect at least one end effector to the motion device, wherein the three-dimensional model of the support structure is generated, in particular automatically, by way of a combination of at least two different optimizers.

All advantages, details, embodiments, and/or features described with respect to the method for producing a support structure are fully transferable to the support structure and to the method for generating a three-dimensional model of a support structure. In particular, using the method for generating a three-dimensional model of the support structure, the three-dimensional model that forms the basis for the method of producing the support structure can be generated. Specifically, by way of the generated three-dimensional model, the support structure can be produced in one piece, in particular as a monolithic part, based on the three-dimensional model of the support structure, as previously described.

### BRIEF DESCRIPTION OF THE DRAWINGS

FIG. 1 a schematic representation of a handling device for handling objects in accordance with an exemplary embodiment;

FIG. 2 a schematic representation of a support structure of the handling device in FIG. 1 in accordance with an exemplary embodiment; and,

FIG. 3 a schematic representation of a sequence of a method for producing a support structure in accordance with an exemplary embodiment.

### DETAILED DESCRIPTION OF THE DRAWINGS

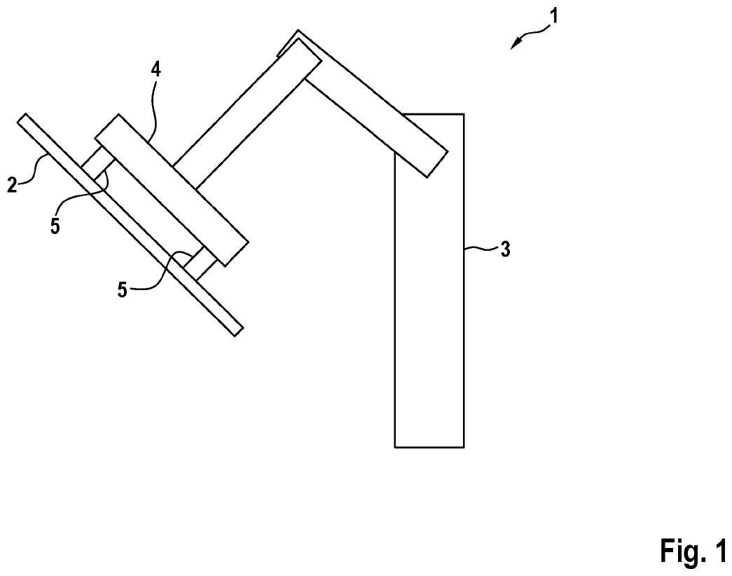

FIG. 1 shows a handling device 1 for handling objects 2, for example vehicle parts. The objects 2 can, in principle, be arbitrary, wherein comparatively large and/or heavy vehicle parts, in particular vehicle roofs, floor assemblies, doors, hoods, and the like, can be handled using the handling device 1. The handling device 1 has a motion device 3, which is shown merely by way of example as a multi-axis robot. The motion device 3 can also be embodied as a gantry device or as other devices suitable for moving the object 2.

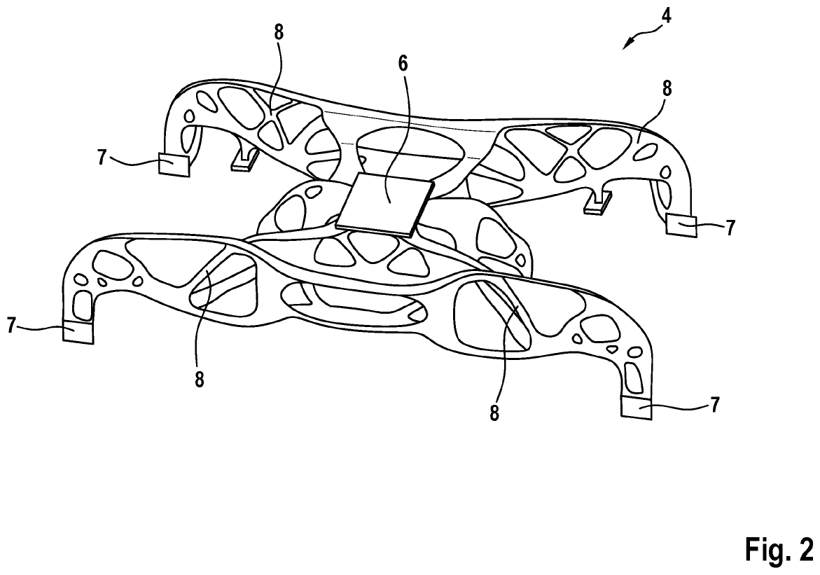

The handling device 1 further comprises a support structure 4 that is coupled to the motion device 3. The support structure 4 thereby connects end effectors 5, for example grippers, suction cups, or the like, to the motion device 3. Purely by way of example, a support structure 4 is shown in detail in FIG. 2. The support structure 4 has connection points, namely, by way of example, a connection interface 6 for connecting the support structure 4 to the motion device 3, for example a mounting plate by which the support structure 4 can be bolted to a flange of the motion device 3. The support structure 4 further has connection points in the form of connection regions 7 at which the end effectors 5, or the at least one end effector 5, can be arranged. It can therefore be seen that all end effectors 5 are connected to the motion device 3 via the support structure 4.

The support structure 4 has a plurality of support elements 8 that connect the connection interface 6 to the connection regions 7. Solely by way of example, the support structure 4 in FIG. 2 is shown in the form of a bionic structure that results from generating a three-dimensional model of the support structure 4. The support elements 8 may interconnect and form a network extending between the connection points. Purely by way of example, the support structure 4 in FIGS. 1 and 2 was produced on the basis of a three-dimensional model of the support structure 4, which model was generated by way of a model-generation process.

In order to generate the three-dimensional model, a combination of at least two optimizers, in particular, can be used. The two or more optimizers are of different types. As can be seen, the support structure 4 in FIG. 2 is produced in one piece, in particular as a monolithic part; that is, no joints, for example bolted joints, weld seams, or other separation lines, are provided, but rather the support structure 4 constitutes a single component from the connection interface 6 to the connection regions 7. The support elements 8 in this case form sub-regions of the support structure 4 but do not constitute separate individual elements; instead they form integral sections of the one-piece support structure 4.

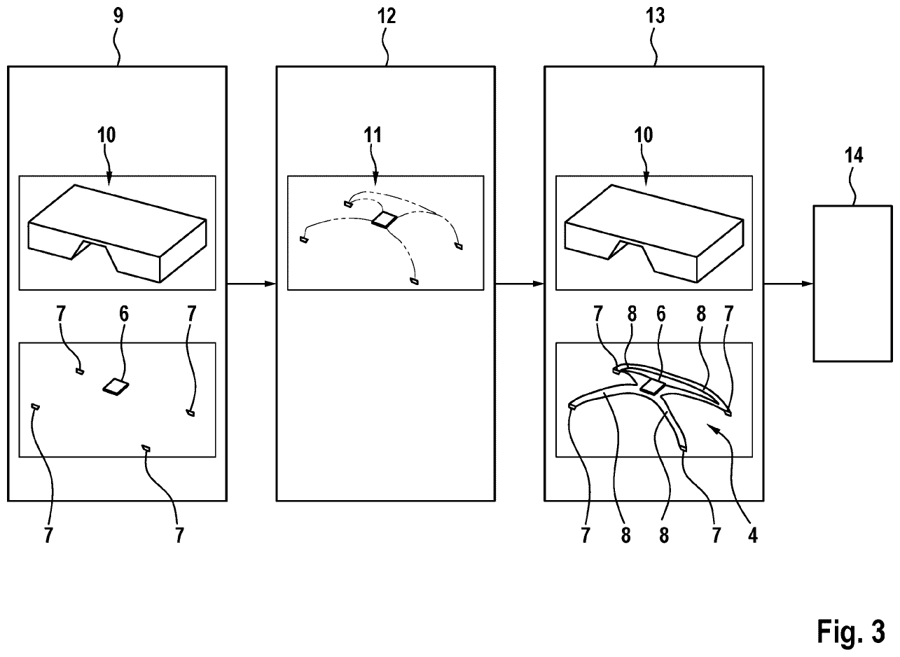

FIG. 3 schematically shows a sequence of a method for generating the three-dimensional model of the support structure 4 and for producing the support structure 4 based on the generated three-dimensional model. In a first block 9, a first optimizer, e.g. a software module, in particular “OptiStruct”, is provided with a build space 10 and boundary conditions, in particular with respect to the connection points, for example the connection interface 6 and the connection regions 7. The boundary conditions may further comprise requirements for the support structure 4, for example forces acting on the support structure 4, torques, a required stiffness or strength, a maximum deformation under load, and the like. The first optimizer can operate, in particular, on the basis of a finite elements method, wherein the build space 10 is subdivided into discrete volume elements and the computation or modeling is carried out. The first optimizer in particular outputs a basic form 11 that defines the spatial arrangement or spatial course of the support elements 8. By specifying the spatial course of the support elements 8, it is ensured that the stiffness or strength of the support structure 4 is sufficient for the required use application. The output of the basic form 11 is shown, by way of example, in a block 12.

The basic form 11 can, in particular, be reduced to a “skeleton” of the support structure 4 or of the model of the support structure 4 and passed to the second optimizer, e.g. a software module, in particular “Emendate”, in a block 13, in which the second optimization is executed. The second optimizer can likewise be provided with the build space 10 in which changes to the model of the support structure 4 may be made; that is, the build space 10 can fundamentally be regarded as the design space. For the second optimizer, the basic form 11 can in particular be defined as an unmodifiable region (within the build space 10), i.e. as a non-design space. Consequently, the second optimizer can make changes only outside the basic form 11, so that the fundamental courses of the support elements 8 remain fixed and cannot be altered by the second optimizer. This ensures that the optimization by the first optimizer, which ensures the stiffness of the support structure 4, remains unchanged.

The second optimizer, which ensures for example that stresses within the support structure 4 lie within specified limits, can therefore only adapt the cross sections of the support elements 8 or their topology in such a manner that they meet the stress requirements of the support structure 4. For this purpose, the second optimizer can perform an iterative refinement of the volume elements of the build space 10. The result of the second optimizer therefore achieves a particularly smooth or soft target surface that requires no further manual reworking. In particular, it is possible to provide an automated process for any desired support structure 4, which process takes as its basis the available build space 10 and the boundary conditions, wherein the finished three-dimensional model can then be output.

The finished three-dimensional model of the support structure 4 can then be supplied to a block 14 in which the support structure 4 is produced. Generation of the three-dimensional model of the support structure 4 therefore comprises blocks 9, 12, and 13, wherein production additionally comprises the block 14 or production comprises the block 14, in which the finished three-dimensional model of the support structure 4 is provided for manufacture. The production of the support structure 4 in block 14 can, in principle, be carried out in any desired manner, provided it is ensured that the support structure 4 is produced in one piece, in particular as a monolithic part. By way of example, the support structure 4 can be built additively, particularly in layers, especially in an SLM or SLS process. Alternatively, based on the generated three-dimensional model of the support structure 4, a casting mold can be produced, in particular additively, so that the support structure 4 can be cast using the casting mold, for example in a sand-casting process. An aluminum die-casting process can be used in this case. The finished support structure 4 can then be demolded and coupled to the motion device 3 or to the end effectors 5.

During production of the support structure 4, it can in particular be provided that the support structure 4 has a completely closed surface or is formed free of cavities. As a result, the support structure 4 is suitable, in particular, for handling objects 2 that impose high cleanliness requirements. In particular, it can be ruled out that contaminants accumulate within the support structure 4 and are randomly released into the working environment. The support structure 4 can therefore also be used particularly in cleanrooms or, alternately, in dirty environments and cleanrooms, because cleaning of the support structure 4 is significantly simplified. Moreover, the substantial assembly effort for providing the support structure 4 is eliminated, because it is made in one piece and does not have to be assembled from individual components of a modular kit. Furthermore, in producing the support structure 4, complete freedom exists with respect to the geometry of the support elements 8 or the support structure 4, since it is not limited to the use of a restricted number of different components of a modular system.

Advantageously, this makes it possible to realize a high weight saving, so that the overall system of the handling device 1 can be improved. By saving weight on the part of the support structure 4, a comparatively heavy object 2 can be handled with the same motion device 3, so that a more powerful motion device 3, which is in particular heavier, more expensive, and more complex and has a higher energy demand, can be dispensed with.

The advantages, details, and features shown in the individual exemplary embodiments can be combined with one another as desired, interchanged, and transferred to one another. As described, the support structure 4 shown in FIG. 2 can be produced using the method described in FIG. 3, wherein the three-dimensional model of the support structure 4 is generated by the method for generating the three-dimensional model of the support structure 4 described with reference to blocks 9, 12, and 13.

Reference signs

| | |
|---|---|
| 1 | handling device |
| 2 | object |
| 3 | motion device |
| 4 | support structure |
| 5 | end effector |
| 6 | connection interface |
| 7 | connection region |
| 8 | support element |
| 9 | block |
| 10 | build space |
| 11 | basic form |
| 12-14 | block |

1.-10. (canceled)

11. A method for producing a support structure for a handling device, in the form of a multi-axis robot, for handling objects comprising vehicle parts, the support structure being couplable to or coupled to a motion device of the handling device, and being configured to connect at least one end effector to the motion device, wherein the support structure is produced as a monolithic part, based on a three-dimensional model of the support structure.

12. The method according to claim 11, wherein the three-dimensional model of the support structure is generated automatically by way of a combination of at least two different optimizers.

13. The method according to claim 11, wherein by way of a first optimizer, a basic form of the support structure that describes a spatial course of support elements is generated.

14. The method according to claim 13, wherein by way of a second optimizer iteratively refining volume elements of a build space, the three-dimensional model of the support structure is generated based on the basic form produced by way of the first optimizer.

15. The method according to claim 14, wherein the basic form generated by the first optimizer defines at least one region that is unmodifiable for the second optimizer, comprising a skeleton of the support structure, wherein the second optimizer performs an adjustment of at least a cross section of an unmodifiable region.

16. The method according to claim 12, wherein for generating the three-dimensional model of the support structure, a build space and connection points of the support structure are specified and, for the first optimizer, at least one boundary condition of the support structure is defined, comprising a force and/or a torque and/or an allowable deformation, wherein the three-dimensional model, comprising the basic form, is generated based on the build space, the connection points, and the at least one boundary condition.

17. The method according to claim 11, wherein the support structure is produced based on the three-dimensional model by way of an additive manufacturing process, or that, based on the three-dimensional model, a casting mold is produced additively, and the support structure is cast.

18. The method according to claim 11, wherein an entire surface of the support structure is produced as a closed surface and/or that the support structure is produced free of cavities.

19. A support structure for a handling device for handling objects comprising vehicle parts, wherein the support structure is produced by way of a method according to claim 11.

20. A method for generating a three-dimensional model of a support structure for a handling device, in the form of a multi-axis robot, for handling objects comprising vehicle parts, the support structure being couplable to or coupled to a motion device of the handling device, and configured to connect at least one end effector to the motion device, wherein the three-dimensional model of the support structure is generated automatically by way of a combination of at least two different optimizers.
